(19) United States
(12) Patent Application Publication
(10) Pub. No.: US 2013/0312027 A1
(43) Pub. Date: Nov. 21, 2013

(54) METHOD, SYSTEM, AND APPARATUS FOR TRACKING AND VISUALIZING VIEWER RESPONSES FOR TELEVISION EVENTS

(71) Applicants: Eyal Baumel, Haifa (IL); Ofry Ram, Rishon Le Zion (IL); Robert Silver, Chicago, IL (US)

(72) Inventors: Eyal Baumel, Haifa (IL); Ofry Ram, Rishon Le Zion (IL); Robert Silver, Chicago, IL (US)

(21) Appl. No.: 13/827,893

(22) Filed: Mar. 14, 2013

Related U.S. Application Data
(60) Provisional application No. 61/647,994, filed on May 16, 2012.

(51) Int. Cl. H04N 21/81

(52) U.S. Cl. CPC H04N 21/8126
USPC 725/34

(57) ABSTRACT

A system, method, and apparatus allows users to communicate with each other during a live broadcast. The users communicate through personal electronic devices like a smartphone preferably running a specially designed application that keeps their messages synchronized with the live broadcast. The application may also prompt them to respond to polls or make predictions. The application also allows for statistics regarding user response to the broadcast to be maintained.

### CROSS REFERENCE TO RELATED APPLICATIONS

The present application claims the benefit of U.S. Provisional Application 61/647,994 filed May, 16 2012 titled “Method, System, and Apparatus for Tracking and Visualizing Viewer Responses for Television Events” and the entirety of its disclosure is incorporated by reference herein.

### FIELD OF THE INVENTION

The field of the present invention generally relates to methods, systems, and apparatus for engaging viewers of a broadcast medium and facilitating viewer interaction with the content and with each other.

### BACKGROUND OF THE INVENTION

Ever since television was introduced, it has been a one-way medium. It pushes content to viewers. Viewers cannot communicate back to the broadcaster or studio regarding the contents of the program or event. They cannot express their thoughts, opinions and emotions on any platform.

Aside from being frustrating for the viewers, this lack of bi-directional communication also poses issues for television content owners who want to know what the audience thinks or feels about the program or event as it happens. To gain insight into viewer perceptions of the programming, television content owners conduct market research through focus groups or hire a third party consultancy like Nielsen who compiles viewer information through its ratings system. While these approaches are better than nothing, they present their own disadvantages.

Focus group research is costly and takes time to compile. A broadcaster must hire someone to conduct the research and then find a group of people to serve as the focus group. Typically, these focus groups are conducted locally—it is extremely expensive to conduct multiple focus groups across the nation. Also, it takes time to compile the results and evaluate them. Above all, focus grouping is an artificial process that must be undertaken entirely aside from producing and distributing (that is, broadcasting) the program. Focus groups usually don't take place while the broadcast airs but after, which makes their results less relevant and precise.

The Nielsen system provides some advantages over focus grouping. Because Nielsen has testing units in households across the country, they are able to gather a more representative sample of television viewership. Because most Nielsen systems gather data electronically, they are able to deliver preliminary results regarding a broadcast more quickly than focus groups. But the Nielsen approach does have drawbacks. While it may collect some viewer feedback, it does not provide the viewer with any additional interactivity relating to the program the viewer is watching or allow him to interact with his friends.

What are needed are systems, methods, and apparatus that provide the viewer with an outlet for sharing his responses to the broadcasted material with his friends. What is also needed ways for broadcasters to provide additional content to their viewers to enrich the viewer experience. What are also needed are improved methods for gaining viewer feedback and reaction organically and quickly so that broadcasters can improve their content

### SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

In overcoming the above disadvantages associated with prior approaches, the various embodiments of the present invention provide a way for viewers to interact with each other and the broadcaster while watching a program on television. The viewers interact with each other using personal electronics devices like smartphones, laptops, smart TV's and tablet computers to access additional content generated by the broadcaster or others. Through their personal electronics devices users are able to respond to the broadcast and send and receive messages to/from their friends. The users may begin a communication by hitting a certain button on their personal communications devices, like an “OMG” button. They may also supplement their communication with text and/or emoticons or other graphics.

Furthermore, the broadcaster may also provide interactive content to users to augment the program. For example, the broadcaster may include a poll at the beginning of the show and then display the results for the poll to the users on their personal electronic devices sometime later in the broadcast. This increases user interest in the broadcast by making the program more interactive. Users may win prizes by participating in polls and predictions or by winning at trivia. Each activity that the user participates in or wins may add to his points total. These points may then be exchanged for prizes. The user may also receive points for communicating using the application. These features turn participating into a game for the user and improves the user's overall experience watching the program. Furthermore, these features encourage the user to state his opinion, but not feel like he is being surveyed, which increases participation and user feedback which can be helpful to broadcasters, advertising agencies, show masters, and other parties. In an embodiment of the present invention, every user's communications are evaluated by a logic engine residing on a server and data is compiled regarding user feedback and attitudes based on the viewers' communications. This data may be used by the broadcaster and/or shared with third parties, like advertisers or marketing agencies. In this specification, the terms “user” and “viewer” are used interchangeably. Also, “program,” “show,” and “broadcast” are used interchangeably.

### BRIEF DESCRIPTION OF THE DRAWINGS

Preferred and alternative examples of the present invention are described in detail below with reference to the following Figure drawings:

FIG. 1 illustrates a user interface displayed on a viewer's personal electronic device in accordance with an embodiment of the present invention;

FIG. 2 illustrates a user interface on a viewer's personal electronic device showing text messages between viewers in accordance with an embodiment of the present invention;

FIG. 3 illustrates a user interface on a viewer's personal electronic device showing a poll in accordance with an embodiment of the present invention;

FIG. 4 illustrates a user interface on a viewer's personal electronic device showing a poll with additional viewer feedback in accordance with an embodiment of the present invention;

FIG. 5A illustrates a user interface for an event editor in accordance with an embodiment of the present invention;

FIG. 5B illustrates a user interface for a start screen of an event editor in accordance with an embodiment of the present invention;

FIG. 6 illustrates a user interface for an event manager displaying event statistics in accordance with an embodiment of the present invention;

FIG. 7 illustrates a user interface for an event manager displaying event statistics in accordance with an embodiment of the present invention;

FIG. 8 illustrates a user interface for an event manager displaying event statistics in accordance with an embodiment of the present invention;

FIG. 9 illustrates a flow diagram by which a user sends a communication in accordance with an embodiment of the present invention;

FIG. 10 illustrates a flow diagram by which a statistics are compiled in accordance with an embodiment of the present invention;

FIG. 11 illustrates a system level diagram of a network employing the invention in accordance with an embodiment of the present invention;

FIG. 12 illustrates a system level diagram of a network employing the invention in accordance with an embodiment of the present invention;

### DETAILED DESCRIPTION

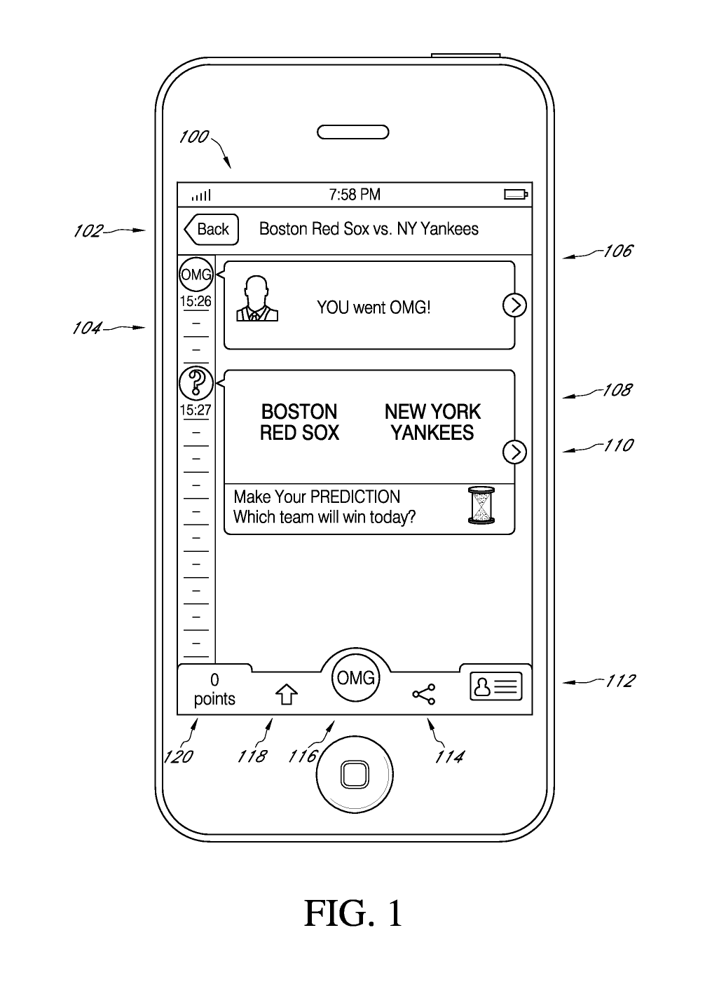

In accordance with an exemplary embodiment of the present invention, FIG. 1 illustrates a user interface 100 as viewed on a viewer's personal electronic device (in this case a smartphone). The user interface 100 includes a title bar 102 complete with a back button which, when pressed, exits the user from the present screen. The user may interact with the application through the buttons at the bottom of the screen. Button 112 is the “view user profile” button. When pressed, the user interface 100 shows the profile for a user which may include an image, name, points, and so on. Button 114 allows a user to share his latest remarks with others through social networks (like Twitter or Facebook) of which he is also a member. Button 118 returns the feed to its top view (or newest card, to be discussed below). By selecting button 118, a user can see what has just happened without having to scroll back through all the cards. In an embodiment of the present invention, a user can return to the top card by clicking the top status bar on his personal electronic device.

In an embodiment of the present invention, the user interface 100 may be an application, or app. The app may be downloaded from an app store like iTunes or Android market. It may also be made available for download from a website. In another embodiment, the user interface 100 may be webpage viewed through a web browser. Either way, whether the user interacts with the embodiment of the invention through an application or through a web browser, it is referred to as “the application” in the specification.

The user may interact with the application in a number of ways. When the user sees something on the program that interests him, he may hit the “OMG” button 116. The “OMG” button 116 then adds in a card (which resembles a text box) to the running dialogue of previous cards. In the present embodiment, when the user hits the “OMG” button 116, a card 106 appears at the top of the user interface 100 beneath the title bar 102 which states “You went OMG” along with a profile image. The user may also be given an opportunity to add additional text or emoticon(s)/image(s) to the card as well. In an embodiment of the present invention, after the user clicks the “OMG” button 116, the “OMG” button 116 is locked for several seconds, to prevent the user from clicking it all the time or to prevent the user from inadvertently hitting it twice.

The running dialogue is shown on the screen of the user interface 100 as a series of cards 106, 108. These cards may display viewer feedback (like 106) or they may include additional content from the broadcaster (like 108, where the broadcaster is prompting a prediction). The cards also may include an arrow 110, selectable by the viewer, that gives the user more information regarding the content of the card. To the left of the cards is a timeline 104, which shows when the viewer contributed to the dialogue or when other interactions, such as a poll, occurred. The timeline may be scaled in a variety of ways. One way is to have the timeline demarcated using hours, minutes, and seconds, starting at zero, when the program starts and counting up from then. Another approach is to simply have the timeline marked off with time at which it is running For example, if a program began at 2:00, the timeline would start at 2:00 and keep going until the program's conclusion, at say 3:00. The timeline may be marked off in minutes or seconds, or into other portions.

While in the present embodiment, a timeline is used to keep track of when messages (typically presented as cards as previously discussed) are sent and synchronize them to the show being watched by the users, the invention is not so limited. The messages, including “OMG” moments, polls, predictions, and the like may displayed without reference to a timeline. Instead they may be time-stamped, with the timestamp either reflecting the time in the show when the message was sent or the actual time. Furthermore, the messages may be presented in the form of a newsfeed.

The user interface 100 of FIG. 1 also includes a points counter 120. When the user is interacting with the application during a program which includes games and/or trivia, he may accrue points. His points count is displayed in the points counter 120.

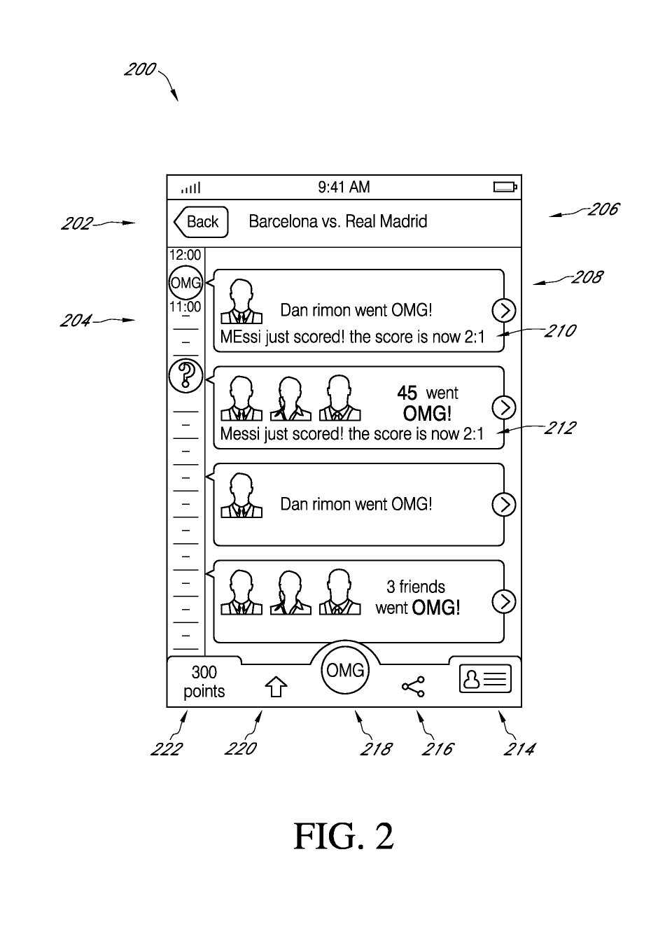

In accordance with an embodiment of the present invention, FIG. 2 illustrates a user interface 200 as viewed on a viewer's personal electronic device which shows a more developed running dialogue between the user of the personal electronic device and another user of the application. The user interface 200 includes a title bar 206 complete with a back button 202 which, when pressed exits the user from the present screen. The user interacts with the application through the buttons at the bottom of the screen. Button 214 is the “view user profile” button. When pressed, the user interface 200 shows the profile for a user which may include an image, name, points, and so on. Button 216 allows a user to share his latest remarks with others through social networks (like Twitter or Facebook) of which he may also be a member. Button 220 returns the feed to its top view (newest card). By selecting button 220, a user can see what has just happened without having to scroll back through all the cards. In an embodiment of the present invention, a user can return to the top card by clicking the top status bar on his personal electronic device.

The user may interact with the application in a number of ways. When the user sees something on the program that interests him, he may hit the “OMG” button 218. The “OMG” button 218 then adds in a card (which resembles a text box) to the running dialogue. In the present embodiment, when another user hits the “OMG” button on his own device (not shown), a card 208 appears at the top of the user interface 200 beneath the title bar 206 which states, in this case, “Dan Rimon went OMG” along with a profile image. The card 208 also includes additional text 210 from the user. Because many viewers may be using the application at the same time, the application may bundle certain responses together to insure that the user interface does not get crowded. In the present embodiment, the application has bundled a set of “OMG”s that occurred roughly simultaneously into one card. To learn more about the users who went “OMG,” the viewer may select the arrow button to the right of the card to bring up more information.

In an embodiment of the invention, the server aggregates user OMGs, and when these OMGs reach a certain threshold (say 5% of all users watching, or 10% of active users watching click OMG within a 30 second time span of each other), an OMG Moment is automatically indicated, which can be sent to the user's device, or the device of his friends who use Bites, or his social network (i.e. Twitter or Facebook newsfeed) so his friends can see. Additionally, individual user OMGs may be sent to friends' devices and his social network. Furthermore, this information (that is, when the OMG moments occurred, who participated, etc.) may be tracked along with other information regarding user interaction and feedback and sent to other parties, like advertisers or the broadcaster, in realtime or saved in a database.

In an embodiment of the present invention, based on user input through OMGs (individual or aggregated as an OMG Moment), the application may deliver real-time video highlights (also referred to as excerpts) of the OMG moment. The time and the duration of the show that corresponds to the OMG moment may be determined in a variety of ways. The application's servers track when users hit the “OMG” button. From this they know during what time period the most people hit the OMG button and use this as the time marker in the show. Then the system may excerpt the previous 30 seconds, or minute, or any other length of time appropriate from the show and deliver a real-time video highlight to friends whether by social networks, email, or other computer or mobile based communication. Alternatively, the time and duration of the excerpt from the show may be determined by how long the rates (number of OMGs received per fixed period of time) of OMGs sent in from users exceeds a certain threshold. Furthermore, the highlight sent out may be extended a certain additional length of time so as to improve the context of the highlight and make it more watchable.

In FIG. 2, the running dialogue is shown on the screen of the user interface 200 as a series of four cards including cards 208 and 212. These cards are tied to the timeline 204 to the left of the cards by an “OMG” placeholder which shows when each user inputted his card into the system (or hit the “OMG” button on his personal electronic device). The cards also may include an arrow, selectable by the viewer, that gives the user more information regarding the content of the card. To the left of the cards is the timeline 204, which shows when the viewer contributed to the dialogue and when other interactions occured. The timeline may be marked off in a variety of ways. One way is to have the timeline demarcated using hours, minutes, and seconds, starting at zero, when the program starts and counting up from then. Another approach is to simply have the timeline marked off with time at which it is running For example, if a program began at 2:00, the timeline would start at 2:00 and keep going until the program's conclusion, at say 3:00. The timeline may be marked off in minutes, seconds, or hours.

The user interface 200 of FIG. 2 also includes a points counter 222. When the user is interacting with the application during a program which includes games and/or trivia, he may accrue points. His points count is displayed in the points counter 222.

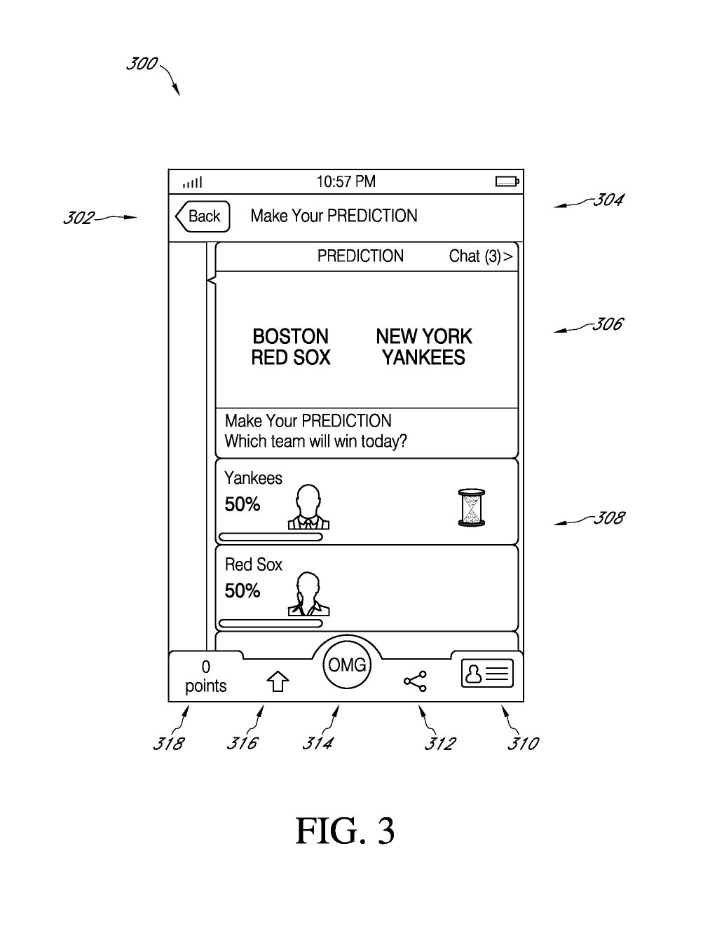

FIG. 3 illustrates a user interface 300 on a viewer's personal electronic device showing a poll in accordance with an embodiment of the present invention. The user interface 300 includes a title bar 304 complete with a back button 302 which, when pressed exits the user from the present screen. The user may interact with the application through the buttons at the bottom of the screen. Button 310 is the view user profile button. When pressed, the user interface 300 shows the profile for a user which may include an image, name, points, and so on. Button 312 allows a user to share his latest remarks with others through social networks (like Twitter or Facebook) of which he may also a member. Button 316 returns the feed to its top view (newest card, to be discussed below). By selecting button 316, a user can see what has just happened without having to scroll back through all the cards. In an embodiment of the present invention, a user can return to the top card by clicking the top status bar on his personal electronic device. The “OMG” button 314 is in the bottom center of the user interface 300. The points counter 318 is to the bottom left of the user interface 300.

In response to the user seeking more information about the poll, the application displays the prediction 306 along with the prediction results 308 on the screen of the user's personal electronic device. The prediction results may be displayed in a number of ways including but not limited to pie charts, numerical representations (number counts), and the like. In the present embodiment, the results are show as percentages with a corresponding bar graph. The profile images of the users who voted are also displayed along with an hourglass which at half full shows the user that there is still time for others to vote. In an embodiment of the present invention, the prediction may also be displayed on the viewers' personal electronic devices once it has been closed and all the votes are added up.

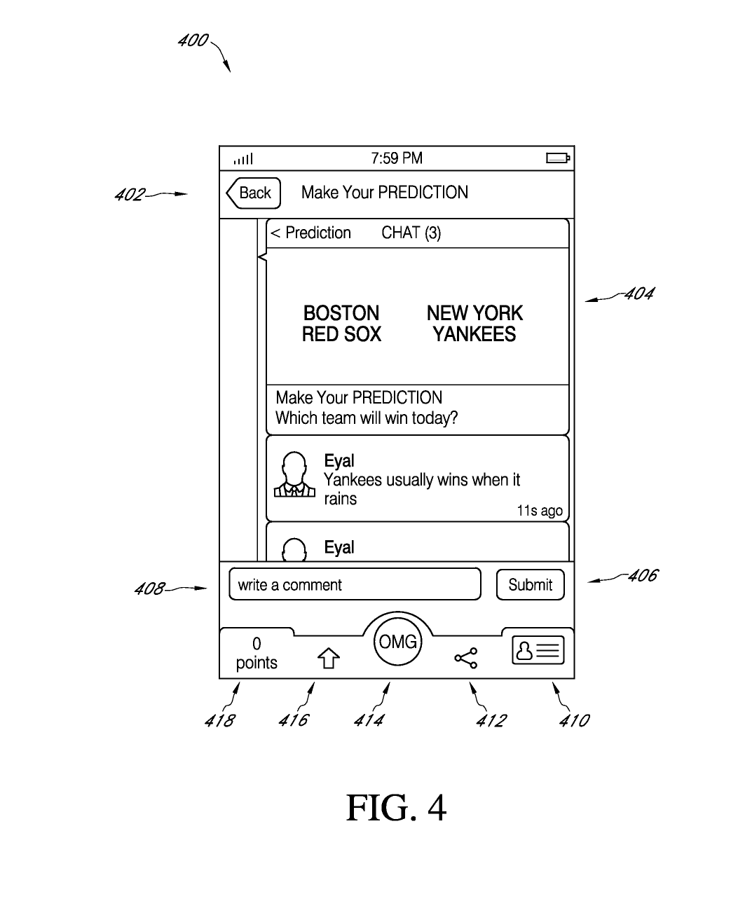

FIG. 4 illustrates a user interface on a viewer's personal electronic device showing a prediction along with a text input window in accordance with an embodiment of the present invention. The user interface 400 includes a title bar 402 complete with a back button which, when pressed, exits the user from the present screen. The user interacts with the application through the buttons at the bottom of the screen. Button 410 is the “view user profile” button. When pressed, the user interface 400 shows the profile for a user which may include an image, name, points, and so on. Button 412 allows a user to share his latest remarks with others through social networks (like Twitter or Facebook) of which he may also be a member. Button 416 returns the feed to its top view (newest card, to be discussed below). By selecting button 416, a user can see what has just happened without having to scroll back through all the cards. In an embodiment of the present invention, a user can return to the top card by clicking the top status bar on his personal electronic device. The “OMG” button 414 is in the bottom center of the user interface 400. The points counter 418 is to the bottom left of the user interface 400.

In response to the user seeking more information about the prediction, the application displays the prediction 404. The user is able to comment on the prediction or make predictions about the game. In the present embodiment, the user may input his comments in the text box 408. The user may input his comments through either a soft or hard keyboard (not shown) or through some other user input device. Once the user is finished inputting his comments, he selects the submit button 406 to have his comments uploaded. They are then presented on his screen as well as the screens of the personal electronic devices of his friends also watching the program. In an embodiment of the present invention, the user may received points for responding to a poll, prediction, trivia, or any other interactive game or the user may be given points if his prediction or trivia response is correct.

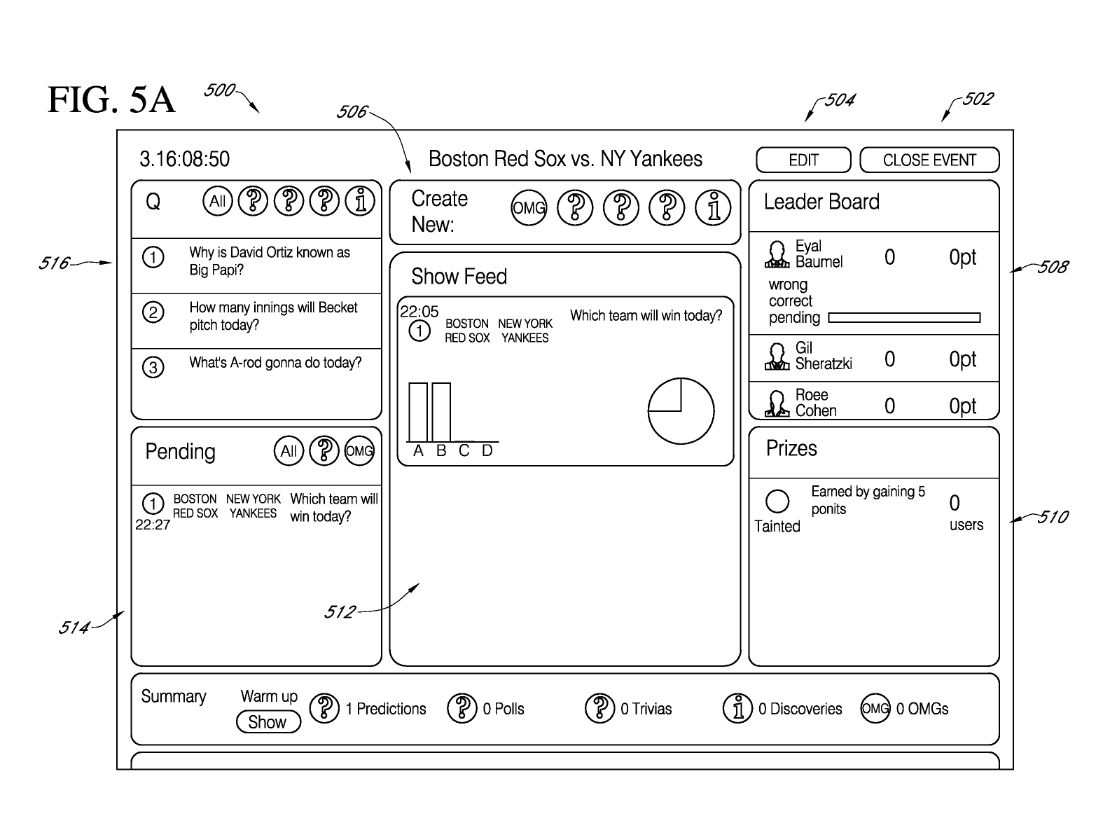

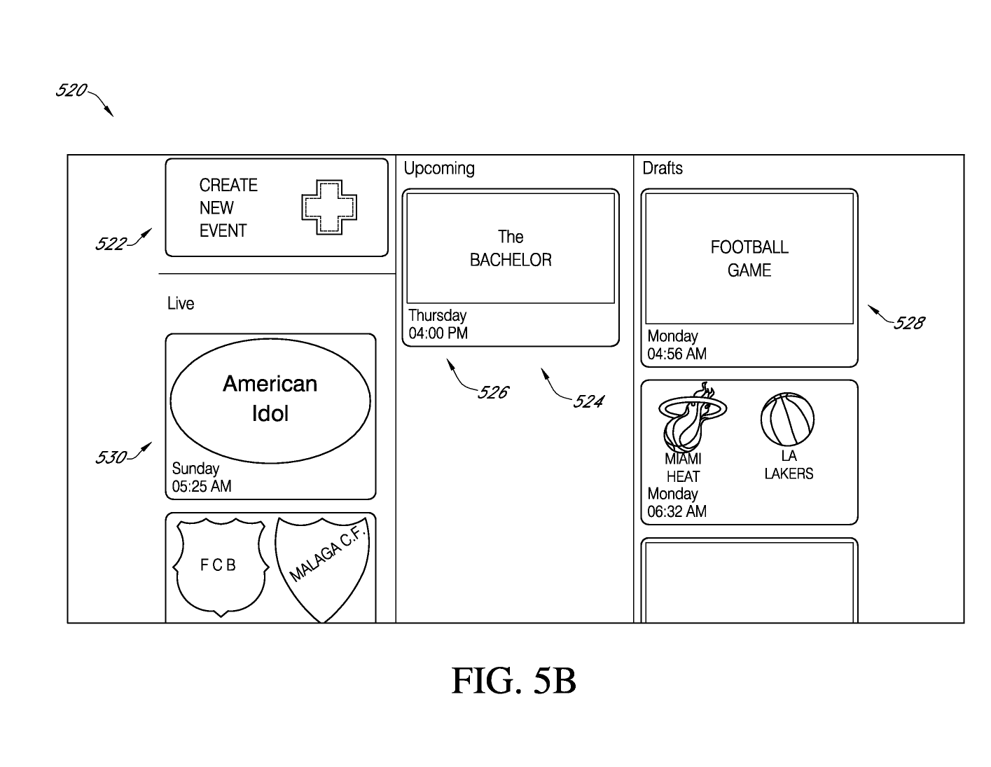

FIG. 5A illustrates a user interface for an event editor 500 in accordance with an embodiment of the present invention. The event editor, also called the dashboard, allows the show master to construct additional content such as trivia, polls, and predictions, among other things to compliment the broadcast program but delivered through each viewer's personal electronic device by the application. The dashboard may be accessed using a web browser. After the show master logs into the event editor website, he selects an event to edit. The event corresponds to a program that will be broadcast in the future or currently being broadcast. That broadcast's name is shown in the title block of the dashboard. The dashboard shows the show master information about what games or trivia will be run during the broadcast. The dashboard includes the leaderboard 508 which shows what viewers have the most points during the broadcast. The prizes window 510 shows what prizes users can win during the broadcast and what point totals are needed to win them. The show feed 512 shows what game or activity is currently being played by viewers through the application. The pending window 514 shows what game or activity is still active with viewers through the application. Window 516 shows the list of activities remaining for the program. The “create new” window 506 allows the show master to select a new game or activity for the viewers to play during the broadcast. In the present embodiment, the show master has five basic types of activity from which to choose: OMG, Prediction, Poll, Trivia, or Discovery. The invention is not so limited. Other types of activities may be included depending on what type of programing is being complimented. Once the user selects one of these types of activity, an interactive wizard appears in a new window and helps the show master create the activity. For example, if the show master selected a new poll, the wizard would appear in a new window and include text entry for the poll question and also includes selectors for how the show master would like the results to be displayed. The wizard also includes selectable options for how long the poll would run and also provides an opportunity for the show master to select a background image.

Before the show master can alter the event, he must select the edit button 504. This insures that the show master does not unintentionally alter the event. Once the show master is finished with the event, he may close it by selecting the close button 502.

FIG. 5B illustrates a user interface 520 for a start screen of an event editor in accordance with an embodiment of the present invention. After logging into the event editor, the show master may be presented with a user interface which gives him the option of editing more than one event. In the present embodiment, the screen is cut into three areas, with events sorted into three types: Live events, Upcoming events, and drafts. At the top of the screen is a “create new event” button 522, which allows the show master to build a new event. In the upcoming events column, there is one event 524, for an upcoming episode of “The Bachelor.” Included on the event is a date and time 526 when the show will be aired. In the live column is an event for an upcoming episode of American Idol, 530. In the drafts column, there are three events shown, including the event for the Phoenix-San Francisco Football Game 528. The events found under drafts are events that have not yet been completed or still need to be finalized before their airtime. Once they are completed, the show master may move them to either the upcoming or live columns. To edit an event, the show master selects the event, typically by clicking on it with a cursor. The event editor for that event is then shown and the show master can go about making adjustments (as shown, for example, in FIG. 5A).

In the present invention, the screen is broken into three columns but the invention is not so limited. The layout of events may be organized by network or by genre. The event buttons may also show more information that the event name that corresponds to the broadcast and the time and date of airing. For example, the event button may also include the name of the network broadcasting the event. Furthermore, the event button may show the show master who created it.

Because programs are often interrupted for commercials, the events editor may include content that anticipates these commercial breaks. When the show master knows at what times the commercial breaks are planned, he may plan an activities like a prediction or trivia to keep viewers engaged over the commercial break. The show master may also want to gather information regarding the commercials shown during the commercial break. He may include polls referring to the commercials and asking questions about them in the event. Furthermore, for commercials that run repeatedly, they may have their own events. Viewer feedback and communications may also be compiled and sent to the broadcasters or other third parties (such as the advertisers or an ad agency).

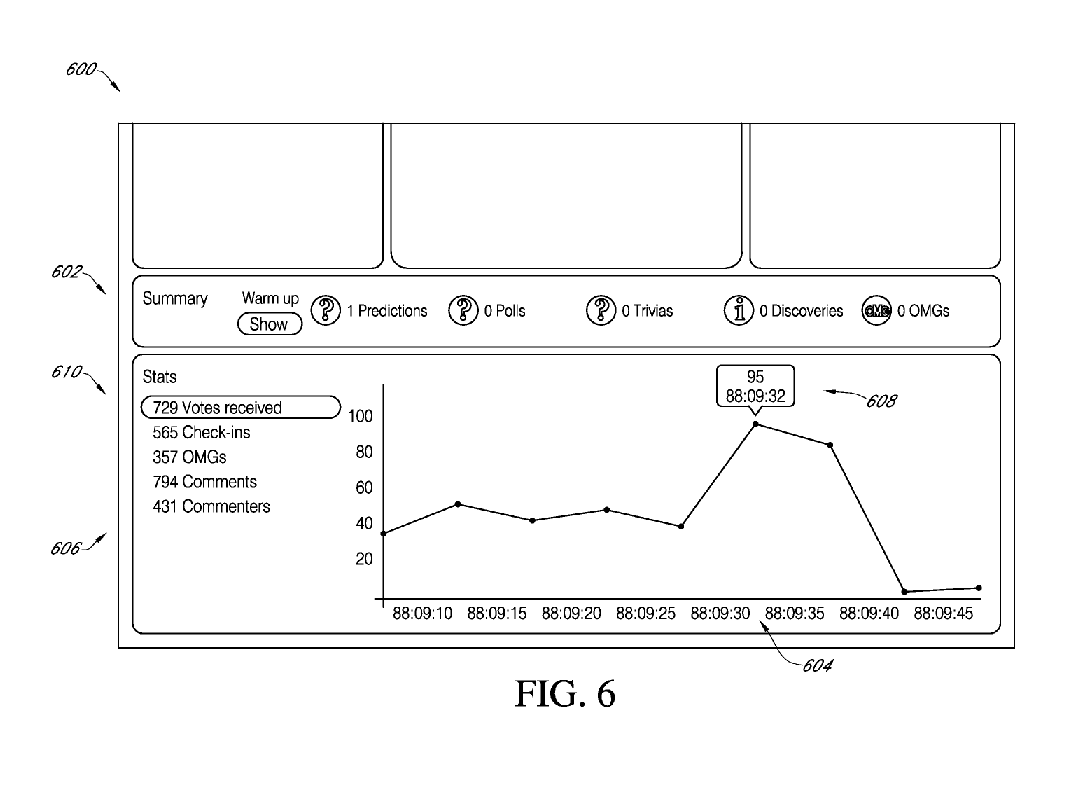

FIG. 6 illustrates a user interface 600 for an event manager displaying event statistics in accordance with an embodiment of the present invention. As the program is being broadcast and viewers are using the application, the application keeps track of viewer feedback in real-time and makes that information available to show masters and others. The summary box 602 keeps track of five types of activities (in this example, Predictions, Polls, Trivia, Discoveries, OMGs) that may occur during the event. The show master may select to see activities that occurred during the show (as shown in FIG. 6) or the activities shown during “warm up,” the period of time preceding the broadcast. The stats window 606 shows the show master a summary of user interactions during the broadcast. The statistics tracked by the application are given on the left-hand side of the window (votes received, check-ins, OMGs, comments, commenters). When the show master selects one of these statistics (in this case, votes received 610), the graph 604 to the right of the statistics list tracks the votes received (on the y-axis) against the time at which they were received (on the x-axis). Points on the line on the graph are selectable. When the show master selects a point, a data box 608 appears, giving a snapshot of what happened at that point (the exact time and the number of votes received).

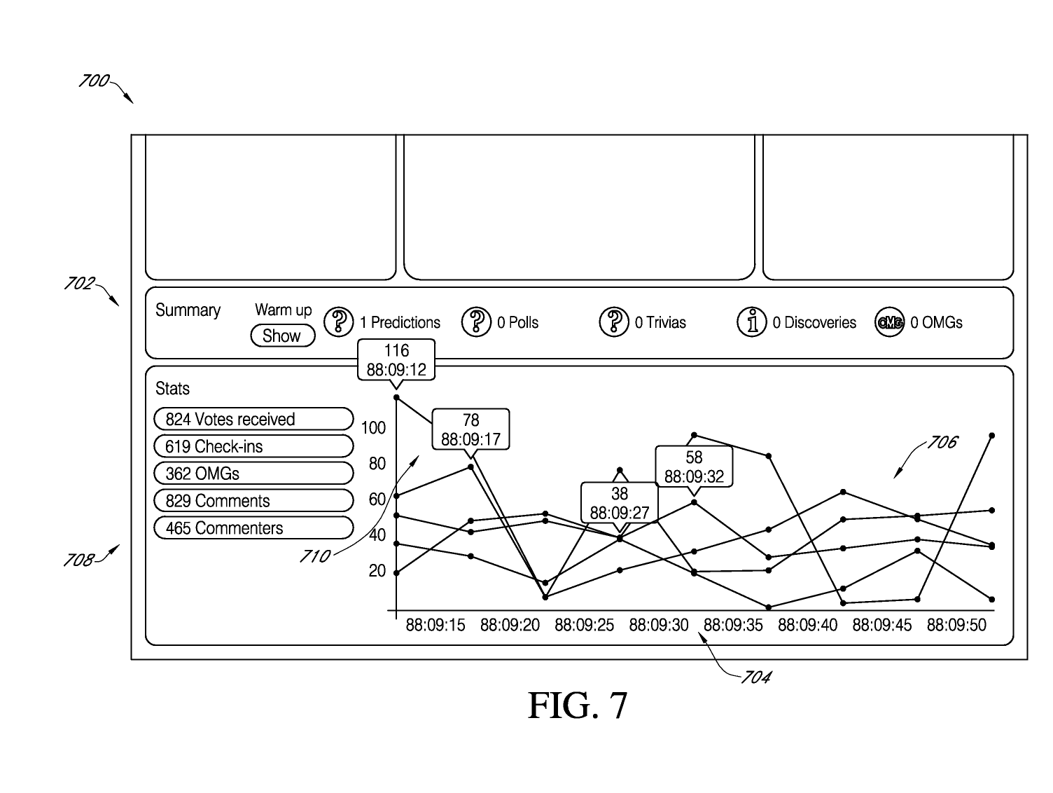

FIG. 7 illustrates a user interface 700 for an event manager displaying event statistics with multiple statistics tracked on a graph in accordance with an embodiment of the present invention. As the program is being broadcast and viewers are using the application, the application keeps track of viewer feedback in real-time and makes that information available to show masters and others. The summary box 702 keeps track of five types of activities (in this example, Predictions, Polls, Trivia, Discoveries, OMGs) that may occur during the event. The show master may select to see activities that occurred during the show (as shown in FIG. 7) or the activities shown during “warm up,” the period of time preceding the broadcast. The stats window 708 shows the show master a summary of user interactions during the broadcast. The statistics tracked by the application are given on the left-hand side of the window (votes received, check-ins, OMGs, comments, commenters). When the show master selects one or more of these statistics (in this case, all statistics are selected), the graph 704 to the right of the statistics list, tracks the votes received (on the y-axis) against the time at which they were received (on the x-axis). To aid the show master in understanding the graphs, each statistic's graph line 706 may be displayed using a different color. In other embodiments, the statistics are displayed using different textures (like broken lines, slashes and dots, etc.) or a combination thereof. Points on the graph are selectable. When the show master selects a point, a data box 710 appears, giving a snapshot of what happened at that point (the exact time and the number of votes received).

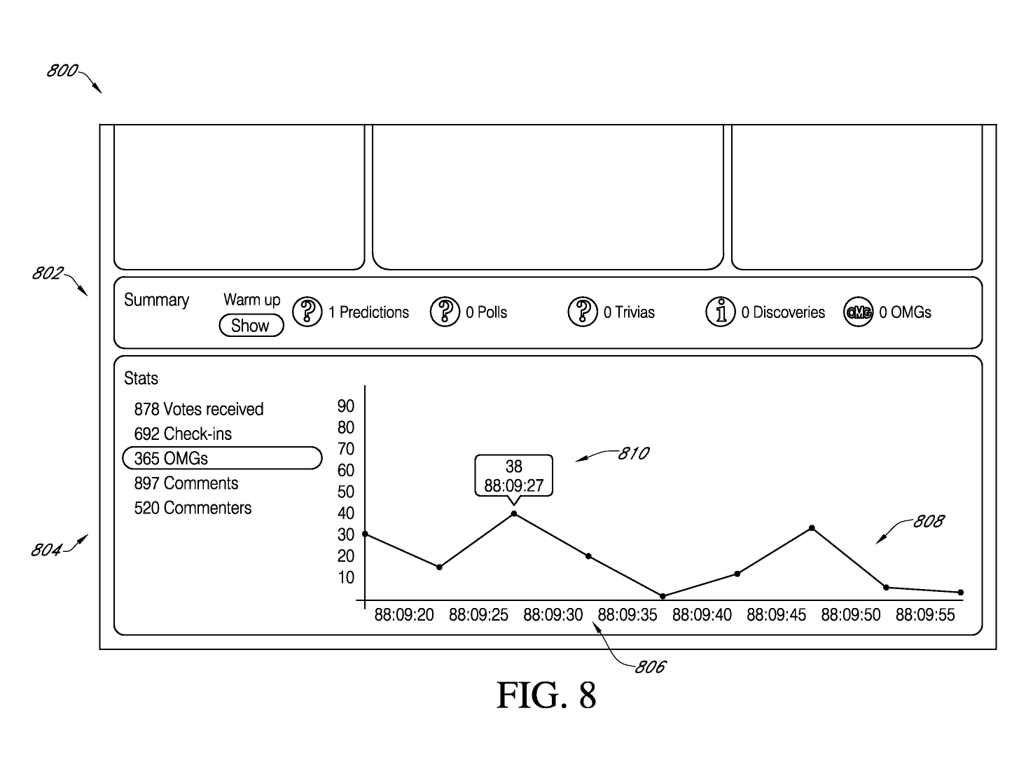

FIG. 8 illustrates a user interface 800 for an event manager displaying event statistics in accordance with an embodiment of the present invention. As the program is being broadcast and viewers are using the application, the application keeps track of viewer feedback in real-time and makes that information available to show masters and others. The summary box 802 keeps track of five types of activities (in this example, Predictions, Polls, Trivia, Discoveries, OMGs) that may occur during the event. The show master may select to see activities that occurred during the show (as shown in FIG. 8) or the activities shown during “warm up,” the period of time preceding the broadcast. The stats window 804 shows the show master a summary of user interactions during the broadcast. The statistics tracked by the application are given on the left-hand side of the window (votes received, check-ins, OMGs, comments, commenters). When the show master selects one of these statistics (in this case, OMGs), the graph 806 to the right of the statistics list, tracks the OMGs (on the y-axis) against the time at which they were received (on the x-axis). Points on the graph line 808 are selectable. When the show master selects a point, a data box 810 appears, giving a snapshot of what happened at that point (the exact time and the number of OMGs).

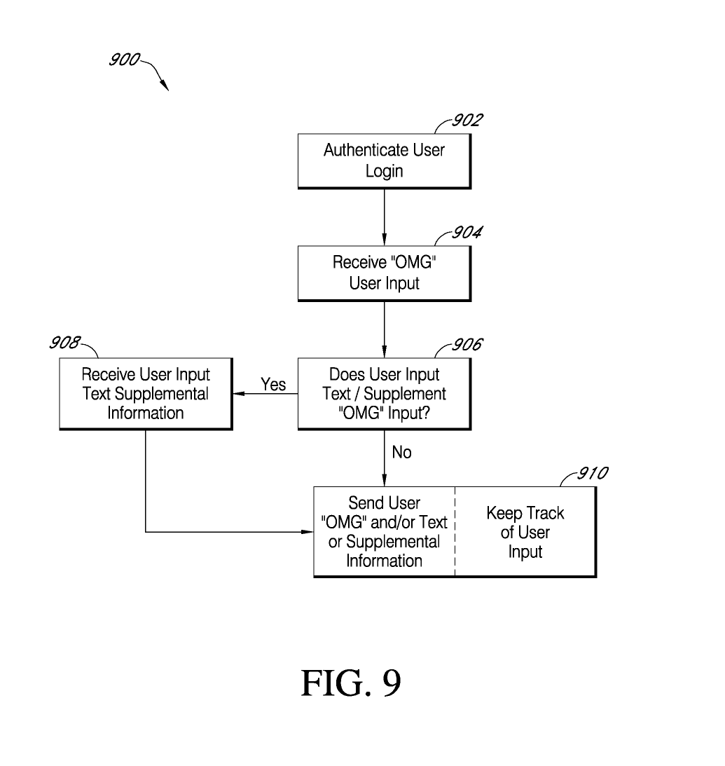

FIG. 9 illustrates a flow diagram 900 by which a user sends a communication in accordance with an embodiment of the present invention. The user begins his interaction with the present embodiment when he logs in and the application's servers attempt to authenticate the user login 902. The user may login by using a username and password or may login by using his Facebook or other social network profile as his credentials. Once the user is logged in and is receiving the event feed for the broadcast he is watching on television, he can see the communications of his friends as well as participate in activities set up by the show master. When the user wants to communicate with his friends, he does so by hitting the OMG button which sends the OMG message to the application server 904. In some instances the user may only want to register his enthusiasm or surprise at what just happened on the television broadcast but, at other times, he may want to add text or an emoticon or other image to his OMG message 906. If the user wants to add text or an emoticon or other image to his OMG message, he inputs it on his personal electronic device and the message is uploaded to the application server 908 and then sent on to the viewer's friends 910. In an embodiment of the present invention, the application server also simultaneously keeps track of user input and compiles them.

The application is able to keep track of who is in the viewer's circle of friends. The viewer may add his circle of friends from another social network, like Facebook. He may also add friends directly through the application. If he knows his friend's username, he may simply add it by inputting it into a text box on an add friend window. The add friend window may also have a lookup function where the viewer can input other information (like a first or last name) and have the system retrieve the username of the friend to be added. A user may also delete a friend from his circle. In an embodiment of the present invention, the application can retrieve a list of all the user's friends. He may then select a friend and view their profile. He may also be able to delete a friend from his circle from this screen. The system is also flexible enough that a user may be able to add or delete a friend, not from his circle but from the event so that that friend does not get his messages and he does not receive that friend's messages either.

FIG. 9 displays the flowchart for what is a common means of receiving and distributing communications from a viewer, but the invention is not so limited. Viewer communication may be prompted by the insertion into the event followed by the user of an activity like a poll (see FIG. 3) or trivia. In this example, the viewer responds to the poll and his input is sent to the application server where it is compiled with the input from other users. Once the poll has closed (say after a set time period has been exhausted), the tabulated results of the poll are then displayed to all viewers participating in the event through the application. Optionally, the viewer's poll response may be sent out to his friends so that they can see how he voted. The user may signal to the application that he wants to participate in the poll by hitting the OMG button or some other way (for instance by selecting the poll card displayed on the viewer's personal electronic device). The application may then display a set of radio buttons next to the options for the poll which the viewer may then select. There may also be a done button which, when pressed, sends the user's input to the application server. Of course, the presentation and selection of polls, predictions, and trivia may be accomplished in any way known in the art including, but not limited to, text boxes, check boxes, selectable menus, and the like.

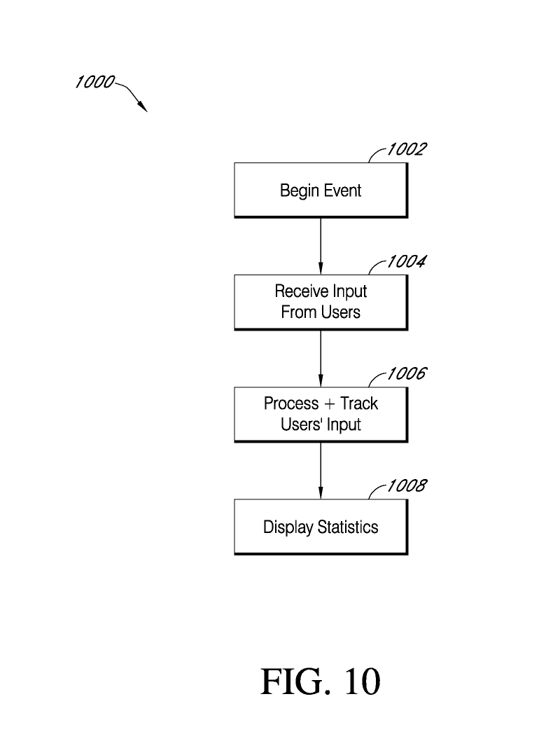

FIG. 10 illustrates a flow diagram 1000 by which a statistics are compiled in accordance with an embodiment of the present invention. The process begins when the event begins 1002 and viewers are logged into the application and participating in the event. As the viewers interact with the activities complimenting the broadcast and communicating with each other, the application server receives input from users 1004. As the server receives user input, it processes it and compiles it 1006. The processing and compiling step is done continuously throughout the program broadcast so that statistics are available to the show master, network, and/or others. Finally, the statistics are displayed 1008. As previously mentioned, in an embodiment of the present invention, statistics are compiled continuously and in real-time as user input is collected by the servers. This allows for preliminary statistics to be available for viewing throughout the duration of the event (as well as after the event has completed).

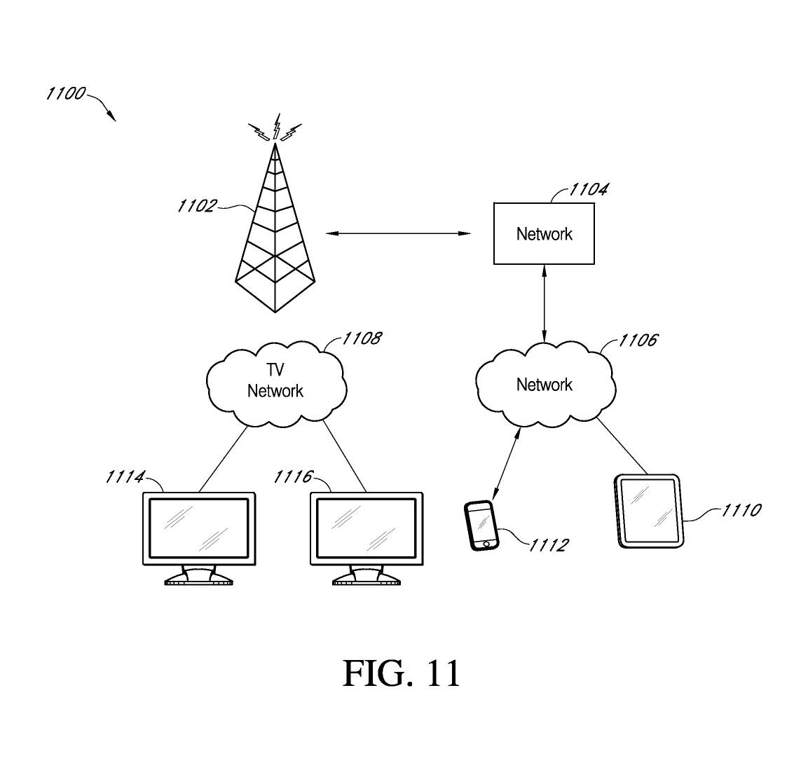

FIG. 11 illustrates a system level diagram of a network 1100 employing the invention in accordance with an embodiment of the present invention. In the present embodiment, there are two distribution networks operating in parallel: the television distribution network 1108 and the network 1106 facilitating communication between the application server 1104 and the various client personal electronic devices, 1112 and 1110. The network 1106 may be the Internet or some other network. It may include both wireless and wireline connections. The client personal electronic devices may be smartphones (like an iPhone or Android phone), tablet computers (like an iPad), laptops, gaming systems, or other types electronic devices. Essentially any electronic device capable of accessing the network and running the accompanying application can act as a client device. In the present embodiment, the viewers watch the broadcast on a television, such as 1114 and 1116. The television may be any device capable of receiving and displaying television signals it receives either over the air or through a satellite, cable, or fiber optic network. The TV network 1108 may be any of these types of network or a combination thereof.

The application server 1104 may also directly communicate with the broadcaster 1102. For example, the broadcaster 1102 may transmit to the application server 1104 the program in advance so that the application server may prepare an event to accompany the broadcast. The broadcaster 1102 may include studios, transmission technology, and other facilities necessary to produce and distribute programming to an audience. The broadcaster may use satellite or other networks to distribute programming to local affiliates who then distribute the programming to viewers over the network.

In FIG. 11, the television distribution network and the network are shown as two distinct networks but the invention is not so limited. Both the television content from the broadcaster 1102 and the communications between the application server 1104 and the client personal electronic devices, 1112 and 1110, may be carried on the same network. Furthermore, in embodiments of the present invention, the functionality of the televisions 1114 and 1116 and the client personal electronic devices 1112 and 1110 may be combined into the same device. For example, a user may watch the television show on his laptop and also run the application on his laptop as well. In an embodiment of the present invention, the application may be run on a cable box or on a smart TV and the user may interact with the application through some device coupled to the television like a remote controller, a wireless keyboard, game controller, and/or a smartphone or tablet computer coupled to the television through a wireless connection.

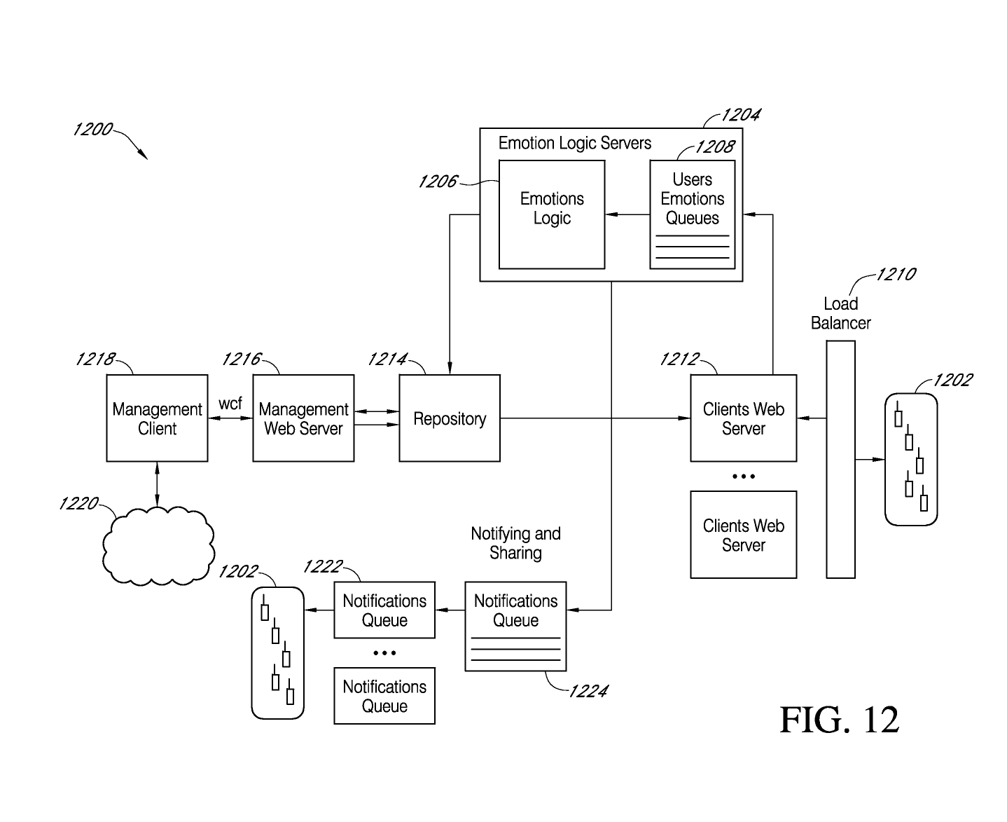

FIG. 12 illustrates a system level diagram of a network 1200 employing the invention in accordance with an embodiment of the present invention. To facilitate expansion or ease of deployment, various components of the system may be outsourced, for example, to Amazon EC2. Client personal electronic devices 1202 (also referred to as client devices) communicate with the client web servers 1212 through a load balancer 1210. The client web servers 1212 may either run Windows or a version of Unix or Linux. In an embodiment of the present invention, the client webservers may run IIS server with small instances (that is, not a lot of memory, CPU, and disk) to insure that all of the users' calls are handled quickly. They receive content from the client devices 1202 through a load balancer 1210 that insures that workload is distributed equally between the computers working as web servers 1212. In an embodiment of the present invention, AWS EC2 load balancers may be used. When the web servers 1212 receive messages from the client devices 1202, they send those messages to the users emotions queue 1208 running on the emotion logic servers 1204. In an embodiment of the present invention, the logic servers and queues are stateless and, therefore, all may be scaled up as much as needed. Furthermore, all the servers may be stateless in an embodiment of the present invention. In an embodiment of the present invention, the emotion logic servers 1204 are based on the .Net FW4.5 standard. In an embodiment of the present invention, the emotions logic engine 1206 takes into consideration the amount of users sending the emotion texts and the time differences between them. The emotions queue 1208 is a queue that stores user messages until they can be processed by the emotions logic engine 1206. In an embodiment of the present invention, the emotions queue is implemented using either SQS (AWS) or MQ Rabbit or both. The emotion logic engine processes the messages so that statistics can be kept by the system regarding viewer interest and response. For example, the emotions logic engine 1206 may parse user messages for words which signify interest (for example “awesome,” “great,” “terrific,” etc.) and make note of when these messages were sent. Once the user messages are processed, they are sent to the repository 1214. The repository 1214 is a database which keeps track of all messages sent by viewers. In an embodiment of the present invention, the repository 1214 may be implemented using a variety of databases such as MySQL or Redis. The repository may also use a memory cache (such as memcache and AWS elasticache, or both). It may also keep track of users, user profile information, and broadcast information. It also stores information regarding show masters and current, future, and past events accompanying television broadcasts.

The repository 1214 sends and receives information from the management webserver 1216 which is connected to the management client 1218. In an embodiment of the present invention, the repository 1214 may have data pushed into it or pulled out of it by other components. The management webserver 1216 stores the data relating the events that a show runner can alter through the dashboard. The graphical user interface for the dashboard is handled by the management client 1218. In an embodiment of the present invention, the dashboard communication technology used is WCF. In an embodiment of the present invention, the GUI for the dashboard is facilitated through a web browser and the management client runs a web server to communicate with the show master's device which is running a web browser. The show master may use any electronic device capable of running a web browser and able to access the network 1220. The network 1220 may be the Internet or any other public or private network.

When the emotions logic server 1204 is done processing the message, it sends it to the notification queue 1224. Other messages, which originate with the emotions logic servers or from other parts of the system may also be sent to the notification queue 1224. For example, a poll relating to the program and generated by the show master is also sent out to the client devices 1202 through the notification queue 1224. The notification service 1222 takes messages from the notification queue 1224 and sends them to the client devices 1202.

In the notification queue and the user emotions queue, the messages may be handled on a first-come, first-serve basis but the invention is not so limited. The queues may prioritize the messages so that the user experience is optimized.

The servers may also communicate with other social network servers (Facebook, Twitter, etc) for authentication purposes but also to collect and share images and video on behalf of viewers. The servers may also collect real time images using Apple and Android push notifications servers (sometime using mediators). The servers may also collect realtime images from services that take realtime pictures and upload them to the Internet, such as Getty Images. They may also monitor Google servers for alerts and collect news from RSS servers.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A computer implemented method comprising:
receiving messages expressing opinions and emotions of a plurality of users who are watching a show; and
visualizing the messages synchronized with the show on a plurality of user devices of the users.

2. The computer implemented method of claim 1, wherein the show is a live event broadcast on television.

3. The computer implemented method of claim 1, wherein the messages are generated by the users pressing a button on the user devices.

4. The computer implemented method of claim 1, wherein a user receives only messages from other users who are the user's friends.

5. The computer implemented method of claim 1, wherein the messages also include user information.

6. The computer implemented method of claim 1, wherein the messages are analyzed for their content and the analysis and messages are stored in a database.

7. A computer implemented method comprising:
tracking statistics of a live broadcast;
receiving a plurality of messages expressing emotions of a plurality of users from a plurality of user devices, wherein the messages are generated by the users pressing a button on the user devices;
tracking statistics of the messages; and
visualizing the statistics of the messages and the statistics of the live broadcast in a timeline corresponding to a progress of the live broadcast.

8. The computer implemented method of claim 7, further comprising:
receiving a plurality of text sequences from the plurality of user devices, wherein the text sequences are generated by the users typing on the user devices to respond to the plurality of messages; and
tracking statistics of the text sequences.

9. The computer implemented method of claim 7, wherein the statistics are visualized on a graph.

10. The computer implemented method of claim 7, wherein statistics are gathered by prompting users with a question and collecting their responses.

11. The computer implemented method of claim 10, wherein the results of the question are displayed to the users on their user devices.

12. The computer implemented method of claim 10, wherein the user receives points for responding to the question.

13. The computer implemented method of claim 10, wherein the user receives points for responding correctly to the question.

14. A system comprising:
a server;
at least two client devices;
a network;
wherein the server and at least two client devices are capable of communicating to each other over the network;
wherein the server receives messages expressing opinions and emotions from at least one client device of a user watching a show;
wherein the server distributes the messages to the client devices which display the messages synchronized the messages with the show; and
wherein a highlight of the show is identified when the number of messages received by the server reaches a certain level.

15. The system of claim 14, wherein the event is a live broadcast on television.

16. The system of claim 14, wherein the messages are generated by the users pressing a button on the client devices.

17. The system of claim 14, wherein a user receives only messages from other users who are the user's friends.

18. The system of claim 14, wherein the messages also include user information.

19. The system of claim 14, wherein the messages are analyzed for their content by the server and the analysis and messages are stored in a database.
